(19) United States
(12) Patent Application Publication
(10) Pub. No.: US 2013/0083036 A1
(43) Pub. Date: Apr. 4, 2013

(54) METHOD OF RENDERING A SET OF CORRELATED EVENTS AND COMPUTERIZED SYSTEM THEREOF

(71) Applicants: Haim Cario, Tel-Aviv (IL); Dmitry Shestak, Netanya (IL); Ohard Zeev Perry, Ginaton (IL); Roi (Roy) Samuelov, Tel-Aviv (IL)

(72) Inventors: Haim Cario, Tel-Aviv (IL); Dmitry Shestak, Netanya (IL); Ohard Zeev Perry, Ginaton (IL); Roi (Roy) Samuelov, Tel-Aviv (IL)

(73) Assignee: Hall of Hands Limited, Tortola (VG)

(21) Appl. No.: 13/585,241

(22) Filed: Aug. 14, 2012

Related U.S. Application Data
(60) Provisional application No. 61/525,197, filed on Aug. 19, 2011.

(51) Int. Cl. G06T 13/00

(52) U.S. Cl. CPC G06T 13/00
USPC 345/473

(57) ABSTRACT

An automated rendering system for creating a screenplay or a transcript is provided that includes an audio/visual (A/V) content compositor and renderer for composing audio/visual (A/V) content made up of at clips and animations, and at least one of: back ground music, still images, or commentary phrases. A transcript builder is provided to build a transcript. The transcript builder utilizes data in various forms including user situational inputs, predefined rules and scripts, game action text, logical determinations and intelligent assumptions to generate a transcript to produce the A/V content of the screenplay or the transcript. A method is also provided for rendering an event that include receiving data with a request from a user to generate an audio/visual (A/V) presentation based on the event using the system. Ancillary data input is provided as a set of rules that influence or customize the outcome of the screenplay.

### CROSS-REFERENCE TO RELATED APPLICATIONS

This application claims priority benefit of U.S. Provisional Application Ser. No. 61/525,197, filed Aug. 19, 2011; the contents of which are incorporated in their entirety by reference herein.

### FIELD OF THE INVENTION

The present invention generally relates to data processing, and more particularly to methods and systems for rendering a screenplay created from data occurring along a timeline that describe or are related to a certain event.

### BACKGROUND OF THE INVENTION

The use of a temporal data to understand about an event is a common technique. The data in the form of tables of values that change as a property or condition evolves with time is often difficult to understand in numerical form. In response to this limited educational content associated with event data in tabular form, video animations of the temporal data corresponding to an event are routinely developed.

A video animation is often used in courtroom settings and movie special effects to provide a visual understanding of the event that is not apparent from the data itself. Additionally, if such a video is generated digitally, an ability exists to change the viewer perspective. With a change in viewer perspective additional insights are gleaned about the event. Such videos have met with limited acceptance owing to the high cost and complexity of generating objects representative of the event actors and progressing the actors through the temporal event data. Such actors can be as varied as humans, vehicles, objects, fanciful creations, or a combination thereof.

Thus, there exists a need for an automated rendering tool for creating a screenplay and audio and visual presentations from data occurring along a timeline that describe or are related to a certain event.

### SUMMARY OF THE INVENTION

An automated rendering system for creating a screenplay or a transcript is provided that includes an audio/visual (A/V) content compositor and renderer for composing audio/visual (A/V) content made up of at clips or animations, and at least one of: back ground music, still images, or commentary phrases. A transcript builder is provided to build a transcript. The transcript builder utilizes data in various forms including user situational inputs, predefined rules and scripts, game action text, logical determinations and intelligent assumptions to generate a transcript to produce the A/V content of the screenplay or the transcript.

A method is provided for rendering an event that include receiving data with a request from a user to generate an audio/visual (A/V) presentation based on the event. The data characterizing the event is processed to obtain attributes of rendering blocks selected from among a existing rendering blocks. Selected rendering blocks are selected from the rendering blocks in accordance with the obtained attributes. A screenplay is generated based on the selected blocks. The generated screenplay is generated with respect to a timeline for the event with a high level rendering logic. The screenplay is then generated into said A/V presentation.

### BRIEF DESCRIPTION OF THE DRAWINGS

FIG. 1A illustrates a high level block diagram of an embodiment of the rendering process for providing a screenplay and audio visual (A/V) content to a device;

FIG. 1B is a generalized flow diagram of an embodiment of the rendering process for providing A/V content;

FIG. 2 illustrates a bock diagram of an embodiment of a A/V content compositor and renderer;

FIG. 3 illustrates a block diagram of an embodiment of a transcript (story screenplay) builder;

FIG. 4 illustrates a schematic diagram of story layers generated by the transcript (story screenplay) builder of FIG. 3;

FIG. 5 illustrates a block diagram of a transcript or storyboard;

FIGS. 6A and 6B are a flowchart illustrating an embodiment of the rendering process;

FIGS. 7A and 7B are a flowchart illustrating rendering requested A/V content for playback from a completed transcript; and

FIG. 8 is a schematic diagram illustrating an overall view of communication devices, computing devices, and mediums for an automated rendering tool for creating visual presentations according to embodiments of the invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention. In the drawings and description, like reference numerals indicate those components that are common to different embodiments or configurations of the present invention.

Unless specifically stated otherwise, as apparent from the following discussions, it is appreciated that throughout the specification discussions utilizing terms such as “processing”, “analyzing”, “calculating”, “rendering”, “generating”, “setting”, “configuring” or the like, refer to the action and/or processes of a computer that manipulate and/or transform data into other data, said data represented as physical, e.g. such as electronic, quantities and/or said data representing the physical objects. The term “computer” should be expansively construed to cover any kind of electronic device with data processing capabilities.

An automated rendering tool is provided for a screenplay based on external data, user supplied data, stored data, and stored audio visual (A/V) content, as well as A/V content generated in response to the user supplied and stored data. In embodiments, data is in various exemplary forms including user situational inputs, predefined rules and scripts, logical determinations and intelligent assumptions. Data is used in specific embodiments to generate a transcript of events for translation into a visual presentation. The visual presentation may be a series of still frames, still frames with accompanying audio and/or description text, and video with audio and/or accompanying text. The visual content may be based on live action actors, or may be computer generated characters, such as avatars; objects such as molecules, fanciful creatures, or vehicles. In an embodiment, the visual presentation may be streamed over a network such as the Internet in response to user data input via an interface such as a Web page.

In accordance with certain aspects of the presently disclosed invention, there is provided a method of rendering a screenplay of an event and a computerized system therefor.

Embodiments of the invention generate a screenplay including a narrative, simulation, or story that may be translated automatically into audio and visual (A/V) content, or the screenplay may be given to a movie producer to shoot a feature movie or television (TV) show, and/or published as a written publication, and/or as a live stage production.

As used herein, “rendering” is defined as a process of generating a graphical or literary representation of data or an object, the object inclusive of players and real or virtual objects. Other grammatical forms such as “renderer” relate to the software operating on a logic device to perform the rendering. In the case of rendering a player or character, it is appreciated that the rendering can be a symbolic avatar, a digital representation of the player, or a combination of an avatar and an actual reproduction of the character.

As used herein, “rendering block” is defined as a unit of graphical or literary information that is suitable for incorporation into an output screenplay.

By way of non-limiting examples, the present invention is applicable for generating a screenplay for visualization of game histories, event-driven business processes, training simulations, educational presentations, automatic editing commercials, news feeds and/or other correlated sets of events.

The operations in accordance with the teachings herein may be performed by a computer specially constructed for the desired purposes or by a general-purpose computer specially configured for the desired purpose by a computer program stored in a computer readable storage medium.

In addition, embodiments of the presently disclosed invention are described without reference to any particular programming language. It will be appreciated that a variety of programming languages may be used to implement the teachings of the presently disclosed subject matter.

The present invention has utility as an automated rendering tool for creating a screenplay for literary and visual presentations based on external data sources, user supplied data, stored data, and stored audio and visual (A/V) content, as well as A/V content generated in response to the external data sources, user supplied and stored data (memory, database, etc.). External data sources may include, but are not limited to, electronic feeds, news feeds, really simple syndication (RSS) feeds, postings on social networks, search engine data, scientific measuring devices, Web crawlers, email, fax, instant messages, text messages, short message service (SMS), broadcast content, etc. Data formats may be plain text, computer languages such as XML, object oriented languages, lower level computer code, binary, etc. Data input is a collection of datum outlined in a chronological manner describing an event, where the event is by way of example real, virtual, or fictitious. In some embodiments, data may be in various forms including user situational inputs, predefined rules and scripts, logical determinations and intelligent assumptions. In embodiments, a set of rules that influence or customize the outcome of the screenplay is referred to as ancillary data. Ancillary data may include user personalization, editorials, specification of target audience, etc. Ancillary data may be from any source (internal and external) and format. Data is used to generate a transcript of events in the form of a screenplay illustratively including a narrative, simulation, or story that may be translated automatically into audio and visual (A/V) content, or the screenplay may be provided directly to a movie producer to shoot a feature movie or television (TV) show, and/or published as a written publication, and/or used as for producing a live stage or theater performance.

The visual presentation may be a series of still frames, still frames with accompanying audio and/or description text, and video with audio and/or accompanying text. The visual content may be based on live action actors, or may be computer generated characters, such as avatars; or objects illustratively including molecules, fanciful characters, or vehicles. In an embodiment, the visual presentation may be generated on a remote host or server and streamed over a network such as the Internet in response to user data input via an interface such as a Web page. In an embodiment, a gaming console or platform within a user household or environment may be used to render a visual presentation in response to user selections and data inputs. In addition, embodiments of rendered content may be displayed and heard on computer displays, portable communication devices, and broadcast receivers such as radio and TV.

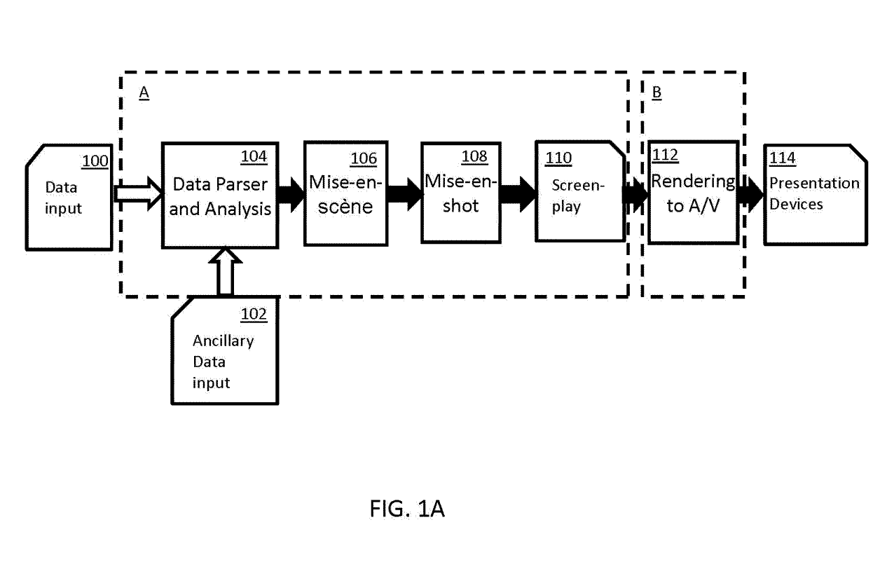

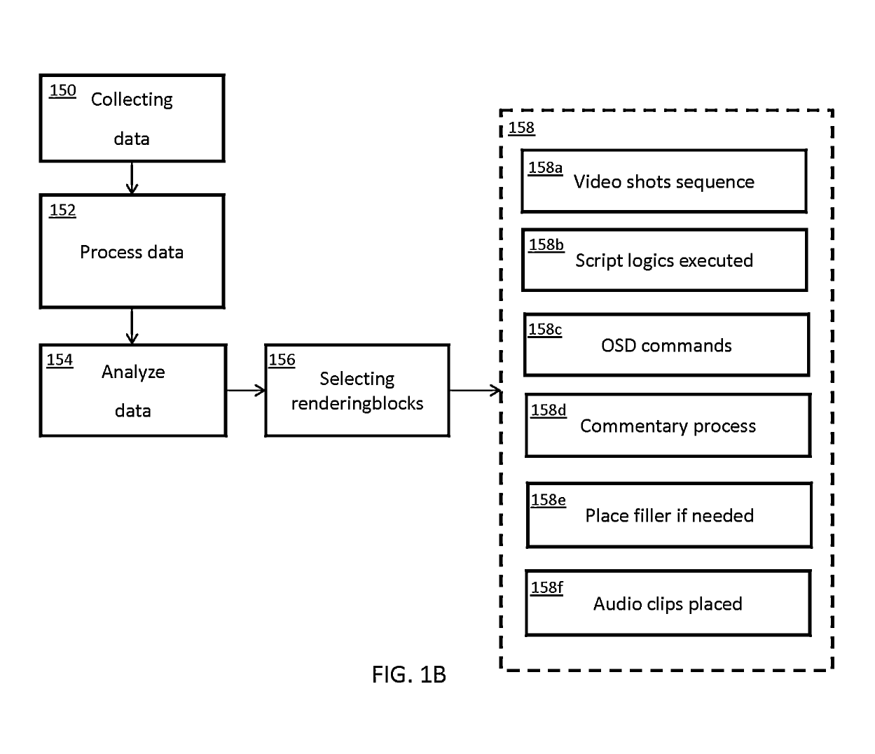

FIG. 1A illustrates a high level block diagram of an embodiment of the rendering process for providing a screenplay and audio visual (A/V) content to a device. The rendering process for a screenplay is provided in area ‘A’ where data input 100 is representative of external data sources, user supplied data, stored data, and stored audio and visual (A/V) content, as well as A/V content generated in response to the external data sources, user supplied and stored data (memory, database, etc.), and ancillary data 102 is inputted into data parser 104 for analysis. The parsing of the inputted data provides information for Mise-en-scène 106 which is “the things in the scene.” These “things” are literally the things put in the picture for to look at. All or some of the things may be significant, but nothing is accidental. This will include performers or actors, set, costume, lighting. Location is another important aspect of mise-en-scène 106. Mise-en-shot 108 is the process of translating mise-en-scène 106 into moving pictures, into shots, and the relationship between the two. The main parameters in embodiments of the invention are determined by the data inputs 102 and 104, and may include camera position, camera movement, shot scale, duration of the single shot, the pace of editing, and depth of focus. The mise-en-shot 108 provides the input to generate a screenplay 110. As shown in FIG. 1A, the screenplay 110 is used to render or generate A/V content 112 in area ‘B’. The A/V content is then provided to presentation devices 114 such as computers, hand held devices, TV, etc.

FIG. 1B is a generalized flow diagram of an embodiment of the rendering process for providing A/V content. For illustrative purposes, the following description is provided for a set of events representing a game history for games of chance and/or strategy. Examples of games illustratively include poker, chess, and checkers. For example, a series of chess movements may be choreographed, or a poker game may be simulated with players with hands of cards and placement of bets based on game related situations as determined by user input, game rules, and logical determinations and intelligent assumptions made by a computing device, which may take the form of artificial intelligence (AI). Those skilled in the art will readily appreciate that the disclosed teachings are, likewise, applicable for any other set of correlated events that may constitute an event stream to be rendered as A/V content. For example, event streams may constitute training scenarios for military or civilian use, such as medical procedure simulations, battlefield simulations or training videos provided from different perspectives based on the same or different data for a given event.

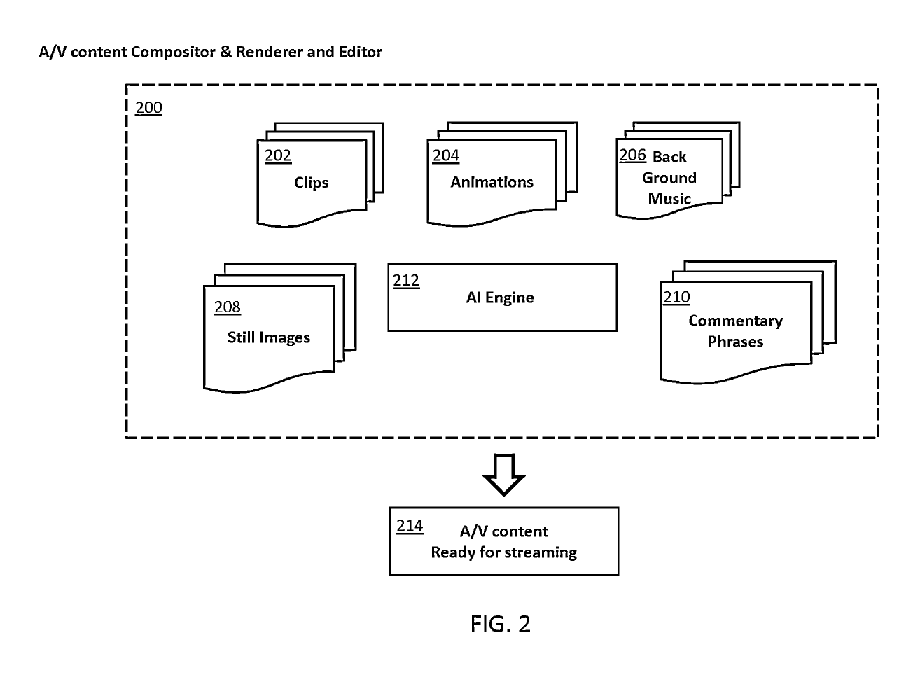

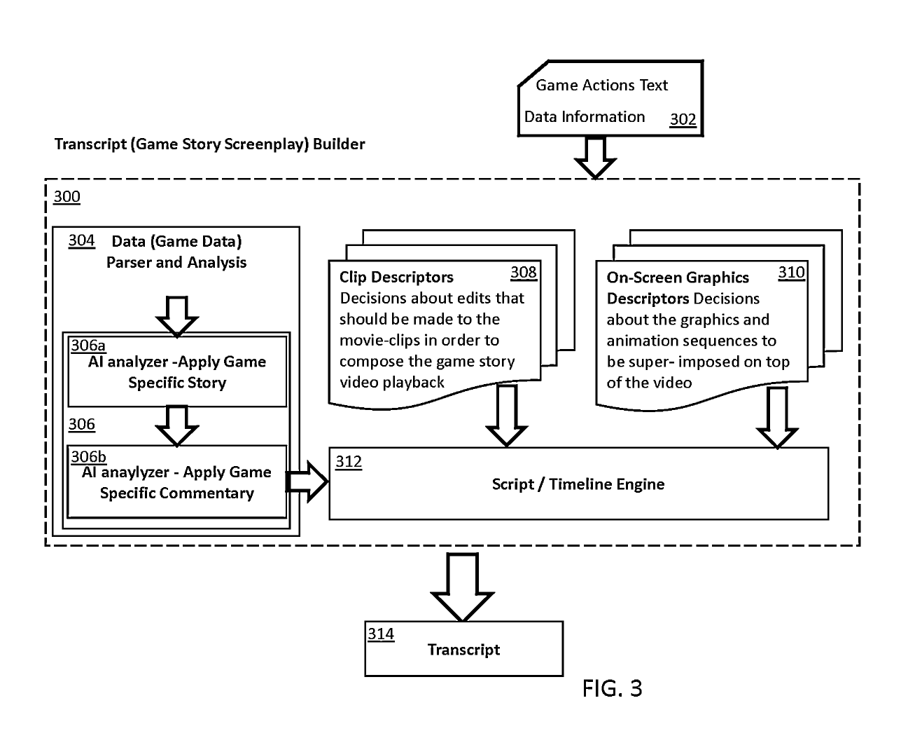

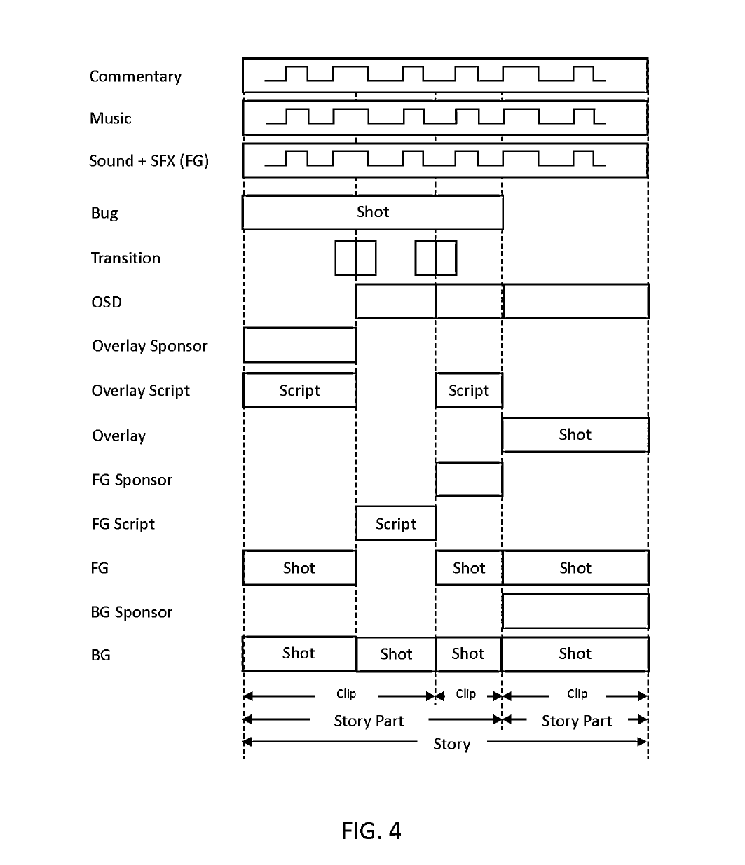

The rendering process of FIG. 1B begins at step 150 by collecting data such as game history and associated information. Data may be obtained with an application running on a user client computer, by allowing the user to submit a Web form with game related information, and/or by obtaining data from a third party, etc. Optionally, the user may be asked to input ancillary data such as their point of view and/or a message to be conveyed to spectators, audiences, and addressees. In step 152, the obtained data is processed within the framework of a high level logic of the specific game considered. Optionally, processing of the data is carried out in consideration with respect to the point of view of the user who wishes to generate the literary or visual presentation or story. Further details with respect to the processing of data are explained with reference to FIGS. 3 and 4. At step 154, the data is analyzed in order to select corresponding rendering blocks of A/V content at step 156 from amongst rendering block that have been prepared in advance as illustrated with reference to FIG. 2. The analysis in step 154 in specific embodiments includes defining event properties related to the story screenplay as will be depicted in the A/V content. An example of an event property is the EDIT MODE property defining duration and compilation of clips to be selected to represent the game flow of the A/V content.

Continuing with FIG. 1B, step 158 for generating a clip or portion of the A/V content is broken up into a series of separate steps 158a-158f. In step 158a, a sequence of video shots is built from the selected rendering blocks from step 156. In step 158b, logic scripts, as noted in FIG. 1b as “script logics” are executed in concert with the data to form a transcript of events to produce additional video shots, audio clips and on screen display (OSD) commands. In step 158c, existing and new OSD (On Screen Display—overlay graphics layer with game related information) commands are processed in order to allow all OSD related events to take place during the playback of the clip of A/V content. In step 158d, a commentary sequence is selected that is related to a game situation, if the high level game logic defines the clip to have a corresponding commentary phrase to be inserted (such selection can be executed, for example, in relation to game stage, table situation, known cards, etc.), and the commentary phrase is synchronized to sync with audio events placed in the clip. In step 158e, a filler clip is added in certain embodiments if commentary started at a predefined sync point ends prior to the clip (a filler clip is a sequence of video shots dedicated to fill the gap and to avoid breaking the story sequence). In step 158f, audio clips are placed in corresponding places in relation to the visual content, in the audio layers of the audio stream

FIG. 2 illustrates an example embodiment of a A/V content compositor and renderer 200 with the rendering elements for composing A/V content made up of at least some of clips 202, animations 204, back ground music 206, still images 208, and commentary phrases 210 to provide a A/V content 214 in the form of a game story in a movie ready for streaming. In order to build the screenplay, the targeted movie comprises a sequence of clips 202. Ordering the clips 202 is defined in certain inventive embodiments by both game history and high level story logic provided by data that forms a transcript of events. High level story logic (alternatively referred to as the “transcript of events”) is a set of editorial decisions made to build a screenplay for literary, movie, or A/V content. High level story logic may include sets of game or simulation specific (e.g., Texas hold'em poker, chess, checkers, black jack, educational, training, etc.) decisions and rules enabling improvement and accuracy of the resulting screenplay that may be used to generate, for example, A/V content. A clip 202 defines a sequence of video and audio related decisions made by compositor and render 200 to describe specific game action. Each clip belongs to specific clip type. Clips 202 can include references to video shots, audio clips, logic scripts, on-screen display (OSD) commands as an overlay graphics layer with game related information and commands, audio sync events, etc.

The transcript of events or logic script per step 158b of FIG. 1B in specific inventive embodiments is a software module that creates a sequence of clips of video and audio to from A/V content, where the A/V content is related to decisions with respect to predefined editor rules, user inputs, other rules, and user point of view and allows creation of best suited video and audio sequence for each game situation. In other embodiments, other conventional techniques of event transcription are used. A clip type may define a specific OSD layout set with related OSD elements. OSD commands are sync events for different OSD elements. Audio clips can be assigned to one of a set of available audio channels. Commentary phrases 210 can be selected by set of artificial intelligence (AI) engines, each engine attached to specific game stage. AI engines 212 can take in to consideration inputs and a wide set of game and editorial parameters in order to select commentary phrase 210 matching not only a current game situation, but also ‘process” matching subsequent or next game events with further commentary phrases, as applicable, building a live and interesting audio story layer to accompany video content.

FIG. 3 illustrates an embodiment of a transcript (story screenplay) builder 300. The transcript builder 300 utilizes data 302 that may be in various forms including user situational inputs, predefined rules and scripts, game action text, logical determinations and intelligent assumptions to generate a transcript 316 for producing A/V content. The transcript builder 300 in certain embodiments includes the following components. A data parser and analyzer 304 analyzes the inputted data 302 that may for example be a description of the game action and related data in accordance with the character that takes part in a specific fragment of the story (player, card dealer, other player, etc.) and/or optionally the inputted point of view of the story teller. A subcomponent of the data parser and analyzer 304 may be an AI analyzer 306, where the intelligent decisions are based on high level logic of the game being simulated or the training scenario being reenacted. In the example shown in FIG. 3, the AI analyzer is split into two components, an AI analyzer 306a for analyzing game specific events, and an AI analyzer 306b for producing commentaries. The parsed data from the data parser analyzer 304 and a collection of clip descriptors 308 and on-screen (OSD) graphic descriptors 310, are supplied to a script/timeline engine 312 that generates the transcript (screenplay) 314. Clip descriptors 308 as well as on-screen graphics descriptors 310 provide information and decisions about edits that should be made to the shots and clips in order to compose a desired A/V content or movie playback (e.g., a poker hand story). The clip descriptor 308 in certain embodiments includes a list of compositing metadata to describe layers of video, audio, graphics and time codes. The clip descriptor 308 can also include information on visual effects such as dissolves and wipers, audio data markers and gains, information on embedded media files and scripts, and the like. A clip descriptor 308 includes source data, metadata and scripts. Source data consists of picture, sound and other forms of data that can be directly perceived. Metadata describes source data, presenting and/or performing features and operations applied onto source data or provide supplementary information about the source data. The clip descriptor 308 may have metadata formatted in various computer languages including, but not limited to, XML or other object oriented languages and markup languages.

Continuing with FIG. 3, the data parser 304 separates the inputted game story into fragments each of which is associated by the artificial intelligence (AI) analyzer 306 with relevant descriptors (308, 310) that will allow the script/timeline engine 312 to select the most suitable shots and scripts that are stored in the database of the system according to the collection of script descriptors. Similarly, the high level game or scenario logic AI analyzer 306, in certain embodiments, analyzes the various game stages, acts, or other temporal fragments that are reflected by the inputted game story or training circumstances. The analyzer 306 in certain embodiments adds: the suitable descriptors to the stage, act, or fragment described hereinabove; the relevant commentary that the AI program 306b associates to the respective stage, act, or fragment; or a combination thereof. A suitable descriptor such that the script/timeline engine 312 identify the optional additions of suitable stored shots, pieces of graphics, audio and background music and sound to be introduced into the relevant part of the story to be told in the A/V content. Scripts within the script/timeline engine 312 in certain embodiments are used to composite a defined duration section with source data based on application business logic.

FIG. 4 illustrates some exemplary story layers generated by the transcript (story screenplay) builder 300. As illustrated, the clip includes a sequence of multiple shots specifying file source material that can be directly perceived. The clip further includes one or more scripts that reference an application business logic that constructs the shot. A sequence of clips constitute a story part, while the whole A/V content, for example story movie playback (e.g. the poker hand story) can be constructed of the various story parts.

The composite operation processes the layers in an ordered manner from background (BG) to foreground (FG); all references to either source material or scripts are indicated in the clip descriptor 308 and are placed in the appropriate layer. The script compositing might introduce additional layers according to the application business logic required. This kind of representation maintains the fidelity and the flexibility of the story timeline.

The illustrated story layers as depicted in FIG. 4 in certain embodiments include the following layers:
a background (BG) having a time marker referencing a shot that is part of the background layer timeline;
a foreground (FG) having a time marker referencing a shot or script that is part of the foreground layer timeline;
an overlay having a time marker referencing a shot or script that is part of the overlay layer timeline;
translations having a time marker that designates the edit transition type, translations should be presented in between shots and/or scripts;
a bug having a time marker referencing either a still or a movie file that is part of the bug layer, once presented the bug is sustained over the whole story timeline unless removed or replaced by a different value;
music having a time marker referencing a music file that is part of the music layer timeline;
audio, sound and special sound effects with the associated time markers for their activation and termination;
a commentary having a time marker for its activation/termination;
an on-screen display (OSD) having a time marker that indicates to the script/timeline (OSD) engine 312 to perform a specific operation on one of the OSD graphics objects;
an event having a general purpose time marker that instructs the rendering engine 200 to perform a specific operation based on the indicated value;
a commercial break having a time marker indicating when a commercial advertisement should be displayed, the story playback head should pause, and continue playing once the ad is displayed in whole, can be placed at any frame of any shot or script.

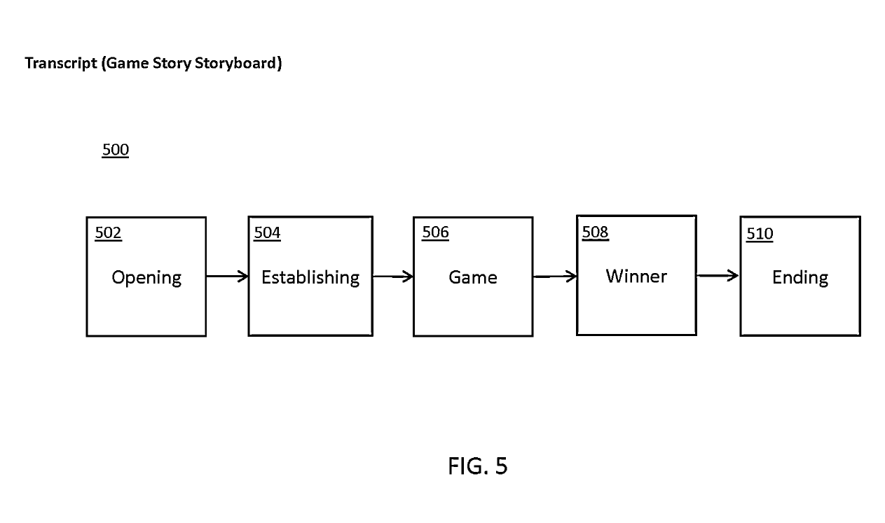

FIG. 5 illustrates a non-limiting example of a transcript or storyboard 500. In the embodiments of the presently disclosed subject matter, each part of the storyboard or transcript in certain embodiments includes one or more elements such as clips, stories, or partial stories corresponding to one or more sources and/or generators of events (e.g. a player, a dealer, other players, etc.). In cases in which the point of view of the user who orders the generating and rendering of the A/V content (movie) is considered, the user point of view and or approach may affect the behavior and gestures of some of the participants that may also appear in the A/V content. It is appreciated that the point of view of other actors or objects in an act, event or fragment are readily used to generate a separate A/V content or incorporated into that generated from the point of view of the user. Non-limiting examples of elements that may be affected by a user perspective may include player's actions, gestures during the game, player's story drama, etc. The storyboard or sequence of A/V content stages in certain embodiments starts with an opening introduction stage 502 or title; and in still other embodiments proceeds to establish 504 the situation that will be depicted. Subsequently, the game 506 or scenario may be played out and a winner 508 or other outcome may be shown, and a concluding sequence or ending 510 may be shown.

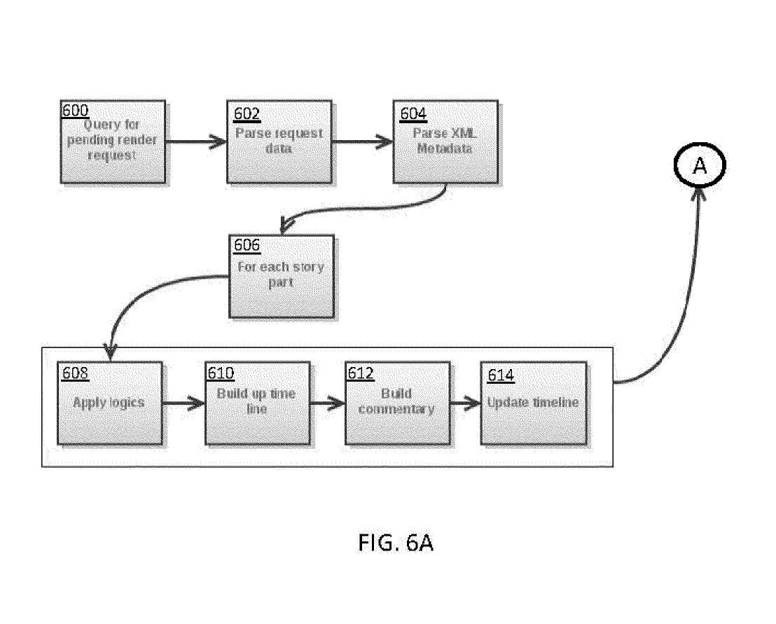

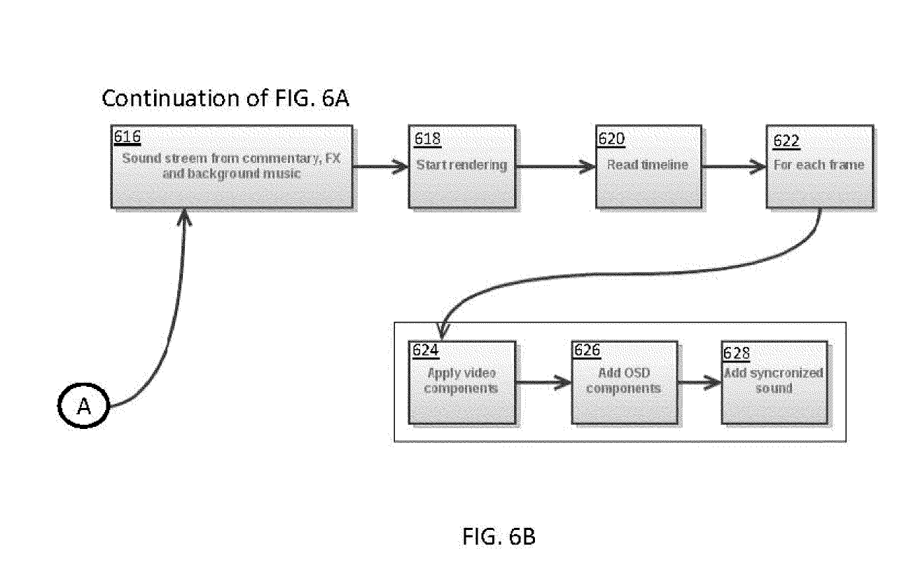

FIGS. 6A and 6B are a flowchart illustrating an embodiment of the rendering process of the aforementioned figures. In step 600, a query to render A/V content is received along with data to be parsed in step 602 by the data parser 304 of the transcript builder 300. Data to be parsed may include metadata 604 in the form of XML or other object oriented language for each portion 606 of the A/V content or story. The AI analyzer 306 applies logic or intelligence (step 608) and a timeline is built (step 610) by the script/timeline engine 312 with commentary (step 612) from A/I analyzer 306b and an updated timeline (step 614) is generated. At step 616, the A/V content compositor and renderer 200 provides a commentary soundstream, special effects (FX) and background (BG) music that may be added to the A/V content. At step 618, rendering is continued by reading the time 620 for synchronizing each frame 622 with video components 624.

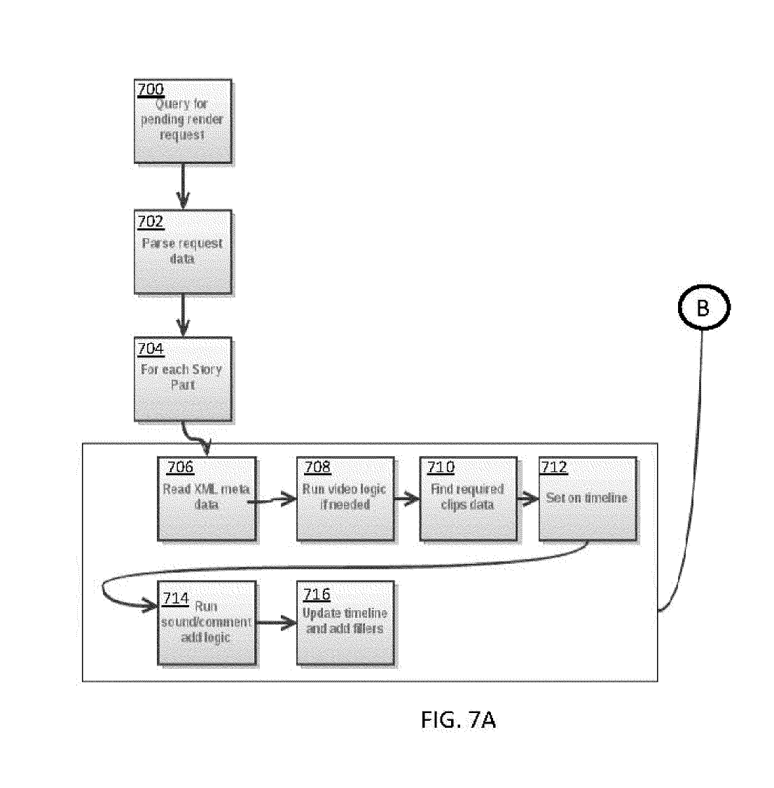

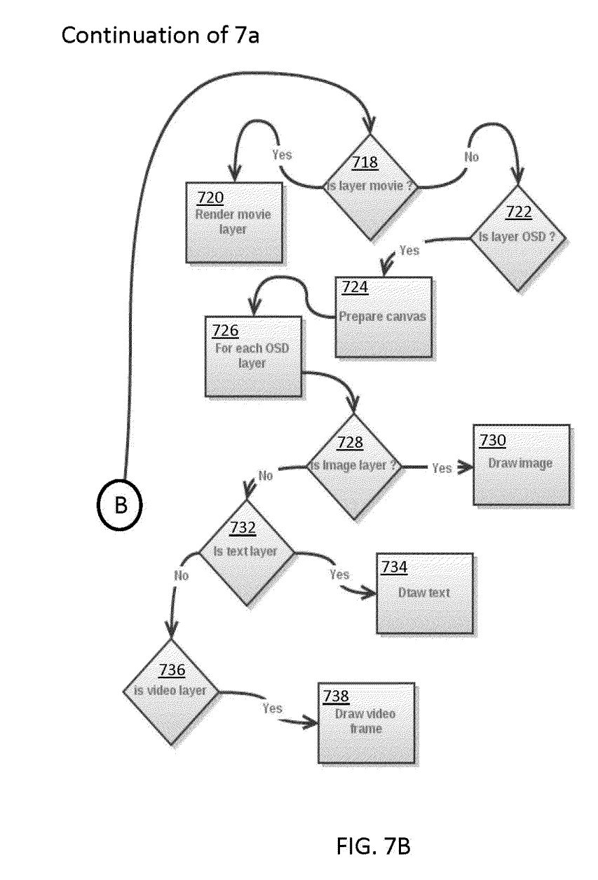

FIGS. 7A and 7B are a flowchart illustrating rendering requested A/V content for playback from a completed transcript. In step 700, a query to render A/V content is received along with data to be parsed in step 702 by the data parser 304 of the transcript builder 300 for each part of the transcript (story). Metadata is read in step 706 and video logic (step 708) to determine the required clips data (step 710) on the timeline (step 712), and to run the corresponding sound track and comments if required by logic analysis (step 714). In step 716, the timeline may be updated and fillers added as described in FIG. 1A for step 108.

Continuing with FIG. 7B at decision step 718, a determination is made on whether a layer is a movie: if yes—the movie layer is rendered (step 720), or if no—a determination is made at decision step 722 on whether the layer is an on-screen display (OSD). If the layer is an OSD layer, a canvas is prepared (step 724) for each OSD layer (step 726). Next a determination is made at decision step 728 if the layer is an image. If the layer is an image, the image is drawn at step 730, or if the layer is not an image the process proceeds to the next decision step 732 where a determination is made on whether the layer is for text. If the layer is for text, the text is drawn at step 734, and if not the process proceeds to the next decision step 736 to determine if the layer is for video. If the layer is for video, a video frame is drawn at step 738. It should be understood that the steps presented in the example(s) above may be parsed differently, performed in different orders, some steps may be omitted, additional steps may be added, and the like.

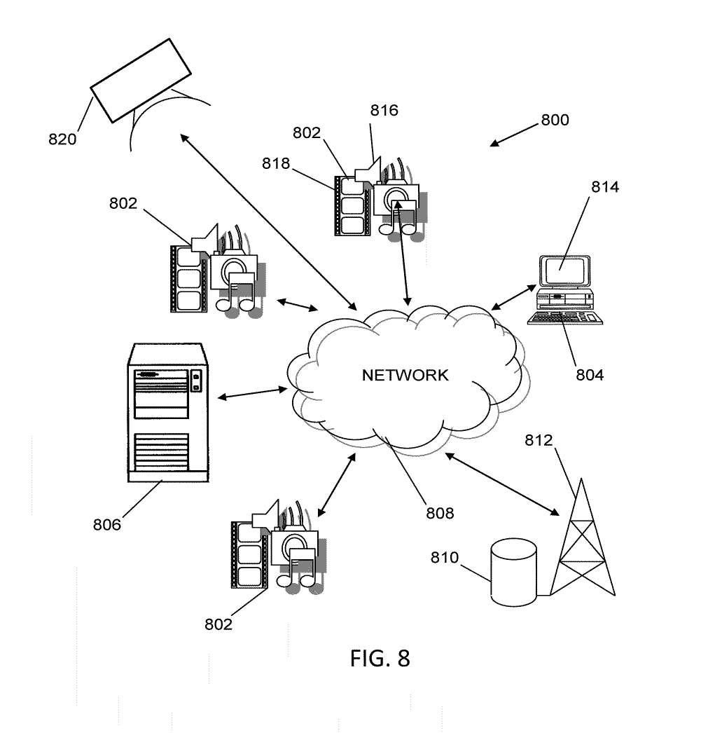

FIG. 8 is a schematic diagram illustrating an overall view of communication devices, computing devices, and mediums for implementing an automated rendering tool for creating screenplays for audio and visual presentations according to embodiments of the invention. The elements of the embodiments of FIGS. 1A-7B are included in the networks and devices of FIG. 8.

The system 800 includes multimedia devices 802 and desktop computer devices 804 configured with display capabilities 814. The multimedia devices 802 are optionally mobile communication and entertainment devices, such as cellular phones and mobile computing devices that in certain embodiments are wirelessly connected to a network 808, as well as dedicated gaming consoles. The multimedia devices 802 typically have video displays 818 and audio outputs 816. The multimedia devices 802 and desktop computer devices 804 are optionally configured with internal storage, software, and a graphical user interface (GUI) for carrying out elements of the automated rendering tool for creating audio and visual presentations according to embodiments of the invention. The network 808 is optionally any type of known network including a fixed wire line network, cable and fiber optics, over the air broadcasts, satellite 820, local area network (LAN), wide area network (WAN), global network (e.g., Internet), intranet, etc. with data/Internet capabilities as represented by server 806. Communication aspects of the network are represented by cellular base station 810 and antenna 812. In a preferred embodiment, the network 808 is a LAN and each remote device 802 and desktop device 804 executes a user interface application (e.g., Web browser) to contact the server system 806 through the network 808. Alternatively, the remote devices 802 and 804 may be implemented using a device programmed primarily for accessing network 808 such as a remote client.

The software for the automated rendering tool for creating a screenplay, of embodiments of the invention, may be resident on the individual multimedia devices 802 and desktop computers 804, or stored within the server 806 or cellular base station 810. Server 806 may implement a cloud-based service for implementing embodiments of the automated rendering tool for creating screenplays with a multi-tenant database for storage of separate client data.

The foregoing description is illustrative of particular embodiments of the invention, but is not meant to be a limitation upon the practice thereof. The following claims, including all equivalents thereof, are intended to define the scope of the invention.

1. An automated rendering system for creating a screenplay or a transcript comprising:
an audio/visual (A/V) content compositor and renderer for composing (A/V) content made up of clips or animations, and at least one of : back ground music, still images, or commentary phrases; and
a transcript builder to build a transcript, said transcript builder utilizes data in various forms including user situational inputs, predefined rules and scripts, action text, logical determinations and intelligent assumptions to generate said transcript to produce said A/V content of the screenplay or the transcript.

2. The system of claim 1 wherein said A/V content is formatted as a movie for streaming over a computer network.

3. The system of claim 2 wherein said movie comprises a sequence of said clips, the sequence defined by both an event history and high level story logic provided by data that forms a transcript of the event.

4. The system of claim 3 wherein said high level story logic includes an event or simulation specific decisions and rules.

5. The system of claim 1 wherein said clips define a sequence of video and audio related decisions made by said A/V content compositor and renderer to describe specific event or simulation action.

6. The system of claim 1 wherein said clips comprise references to video shots, audio clips, logic scripts, OSD (on-screen display) commands, and audio sync events.

7. The system of claim 6 wherein said logic scripts are a software module that creates a sequence of clips of video and audio to from said A/V content, where said A/V content is related to decisions with respect to at least one of predefined editor rules, user inputs, other rules, or user point of view and allows creation of best suited video and audio sequence for each game or simulation situation.

8. The system of claim 1 wherein said commentary phrases are selected by a set of artificial intelligence (AI) engines within said A/V content compositor and renderer, each AI engine attached to a specific game or simulation stage; and
wherein said AI engines take into consideration input that influences a set of editorial parameters in order to select commentary phrases matching not only a current game or simulation situation, but subsequent game or simulation events and match following commentary phrases, building an audio story layer to accompany video content.

9. The system of claim 1 further comprising a Web interface on a client device configured with a display for viewing said A/V content and for entry of said data.

10. The system of claim 1 wherein said data further comprises character data in accordance with a character including a player, card dealer, or other player that takes part in a specific fragment of the screenplay or the transcript and optionally the A/V content is presented from a point of view of a storyteller.

11. The system of claim 1 wherein said data further comprises character data in accordance with a character that takes part in a specific fragment of the A/V presentation or the inputted point of view of a story teller.

12. The system of claim 1 wherein said transcript builder further comprises a data parser and analyzer and a script/timeline engine.

13. The system of claim 12 wherein said data parser and analyzer further comprises an AI analyzer, where the logical determinations and intelligent assumptions are based on high level logic of a game being simulated or a training scenario being reenacted.

14. The system of claim 13 wherein said AI analyzer produces commentaries.

15. The system of claim 12 wherein said script/timeline engine receives a set of parsed data from said data parser and analyzer and a collection of clip descriptors and on-screen (OSD) graphic descriptors to generate said transcript.

16. The system of claim 15 wherein said clip descriptors form a list of compositing metadata to describe layers of video, audio, graphics and time codes.

17. The system of claim 15 wherein said clip descriptors include information on visual effects including dissolves and wipers, audio data markers and gains, information on embedded media files and scripts.

18. The system of claim 1 further comprising ancillary data being input into said transcript builder.

19. A method of rendering an event, the method comprising:
receiving data with a request from a user to generate an audio/visual (A/V) presentation based on said event;
processing said data characterizing said event to obtain attributes of rendering blocks selected from among a plurality of existing rendering blocks;
selecting from the plurality of rendering blocks in accordance with the obtained attributes a selected plurality of rendering blocks;
generating a screenplay comprising the selected plurality of rendering blocks;
rendering the generated screenplay with respect to a timeline for the event with a high level rendering logic; and
translating said screenplay into said A/V presentation.

20. The method of claim 19 further comprising streaming said A/V presentation to said user over a network.
